(19) United States
(12) Patent Application Publication
(10) Pub. No.: US 2009/0053920 A1
(43) Pub. Date: Feb. 26, 2009

(54) ELECTRONIC CARD ARRANGEMENT

(75) Inventors: Clint Wilber, San Diego, CA (US); Bob Hertlein, San Diego, CA (US)

Correspondence Address: FOLEY & LARDNER LLP, P.O. BOX 80278, SAN DIEGO, CA, 92138-0278, US

(73) Assignee: Novatel Wireless, Inc.

(21) Appl. No.: 11/845,002

(22) Filed: Aug. 24, 2007

(51) Int. Cl. H01R 13/62

(52) U.S. Cl. 439/159; 439/296

(57) ABSTRACT

An electronic device includes a connector for interfacing with a host device and an electronic card receiving portion. The electronic card receiving portion is configured to inhibit physical removal of an electronic card therein when the connector is interfaced with the host device.

### BACKGROUND OF THE INVENTION

The present invention relates generally to the field of electronic devices and, more particularly, to electronic devices adapted to have removable electronic cards inserted therein.

Many communication devices, such as cellular telephones and wireless modems, are provided with an electronic card which may include data or software. Typically, such electronic cards may include identification information for identifying the device or the user to a network or another device. For example, many such devices include a subscriber identity module (SIM) card.

In many devices, this electronic card is removable. However, inadvertent removal of the card can cause many difficulties. For example, if a SIM card is removed from a wireless modem on a personal computer, the personal computer may require rebooting or reconfiguring.

### SUMMARY OF THE INVENTION

In one aspect of the invention, an electronic device includes a connector for interfacing with a host device and an electronic card receiving portion. The electronic card receiving portion is configured to inhibit physical removal of an electronic card therein when the connector is interfaced with the host device.

In one embodiment, the electronic card receiving portion is part of a housing. The housing may be formed of molded plastic or plastic extruded on or attached to a metal. The electronic card receiving portion may be an insert secured within the housing. The insert may be formed of an amorphous alloy.

In one embodiment, the electronic card receiving portion includes tracks along which the electronic card can be inserted or removed.

In one embodiment, the electronic card receiving portion includes a card ejection slot adapted to facilitate removal of the electronic card.

The connector may be a universal serial bus (USB) connector. The electronic card receiving portion is positioned such that an electronic card inserted therein is positioned above or below the USB connector.

In one embodiment, the electronic card receiving portion is adapted to receive a subscriber identity module (SIM) card.

In another aspect of the invention, a modem device includes a universal serial bus (USB) connector for interfacing with a host device and an electronic card receiving portion. The electronic card receiving portion is configured to inhibit physical removal of an electronic card therein when the USB connector is interfaced with the host device.

In another aspect, the invention relates to a modem system. The system includes a universal serial bus (USB) connector for interfacing with a host device, an electronic card receiving portion, and an electronic card removably positioned within the electronic card receiving portion. The electronic card receiving portion is configured to inhibit physical removal of the electronic card therein when the USB connector is interfaced with the host device.

### BRIEF DESCRIPTION OF THE DRAWINGS

FIG. 1 is a perspective view of an exemplary electronic device according to an embodiment of the present invention with an electronic card partially inserted;

FIG. 2 is a perspective view of the inside of the upper housing of the exemplary electronic device with an electronic card partially inserted;

FIG. 3 is a perspective view of the exemplary electronic device with the upper housing shown as a wireframe with an electronic card partially inserted;

FIG. 4 is a perspective view of the exemplary electronic device with an electronic card completely inserted;

FIG. 5 is a perspective view of the inside of the upper housing of the exemplary electronic device with an electronic card completely inserted; and

FIG. 6 is a perspective view of the exemplary electronic device with the upper housing shown as a wireframe with an electronic card completely inserted.

### DETAILED DESCRIPTION OF THE PREFERRED EMBODIMENTS

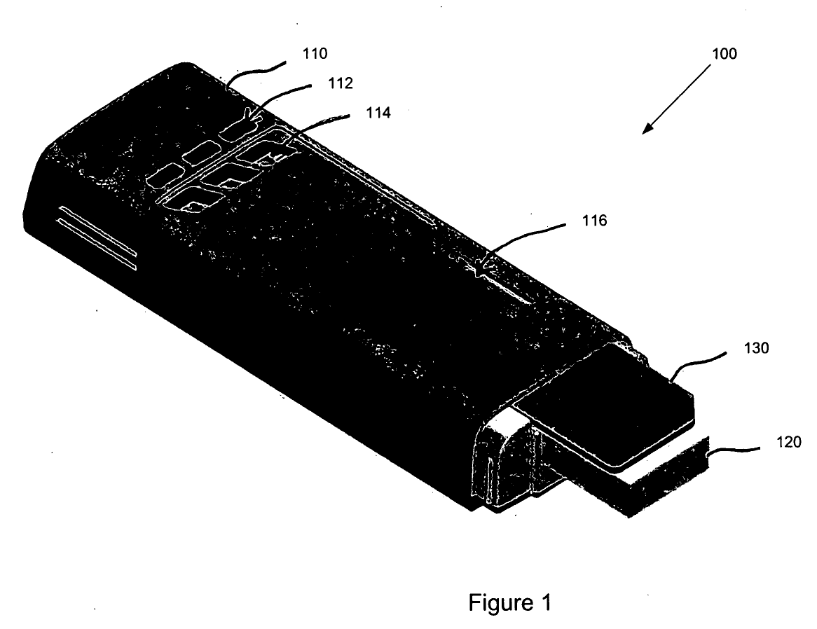

Referring to FIG. 1, an electronic device according to an embodiment of the present invention is illustrated. The electronic device 100 may be any type of electronic device with electronic components therein. In the illustrated embodiment, the electronic device 100 is a modem device adapted to provide wireless communication.

The electronic device 100 includes an upper housing 110 inside which the various components of the electronic device 100 may be secured. For example, electronic components necessary for the operation of the modem device, such as printed circuit boards with power centers, processors and antennas, may be secured within the upper housing 110. The upper housing 110 may be made of a variety of materials. In one embodiment, the upper housing 110 is formed of molded plastic or plastic extruded on or attached to a metal, such as an amorphous alloy (e.g., Liquidmetal®).

The upper housing 110 is provided with two sets of openings 112, 114. The first set of openings 112 is adapted to provide ventilation for the electronic device 100. In this regard, the ventilation may be passive. Additionally, a second set of openings 114 is provided to facilitate configuration (or reconfiguration) of the electronic device. For example, the set of openings 114 may be opening for Joint Test Action Group (JTAG) pins. The set of openings 114 may allow for configuration of the modem device for specific uses, for example.

In the illustrated embodiment, the electronic device 100 is provided with a connector 120 for interfacing the electronic device 100 with another device (not shown), such as a host device. In this regard, a host device may be any of a variety of devices, including communication devices. For example, in the case of wireless modem device, the electronic device 100 may be interfaced with a host device such as a desktop computer, a laptop computer, a personal digital assistant or the like. In this regard, when interfaced with a host device, the electronic device 100 provides wireless communication capability to allow the host device to communicate with, for example, a network such as a wireless local area network (WLAN), a cellular network or another device. In the illustrated embodiment, the connector 120 is a universal serial bus (USB) connector.

FIG. 1 illustrates an electronic card 130, such as a subscriber identity module (SIM) card, partially inserted into the electronic device 100. As described in greater detail below, the electronic card 130 is accommodated by the electronic device 100 in an electronic card receiving portion. A card ejection slot 116 is formed on the electronic card receiving portion and/or the upper housing 110 to facilitate removal of the electronic card 130. In this regard, when removal is desired, a user may insert an object, such as a pin, pen or pencil, and push an edge of the electronic card 130 such that the electronic card 130 is ejected from the electronic device 100.

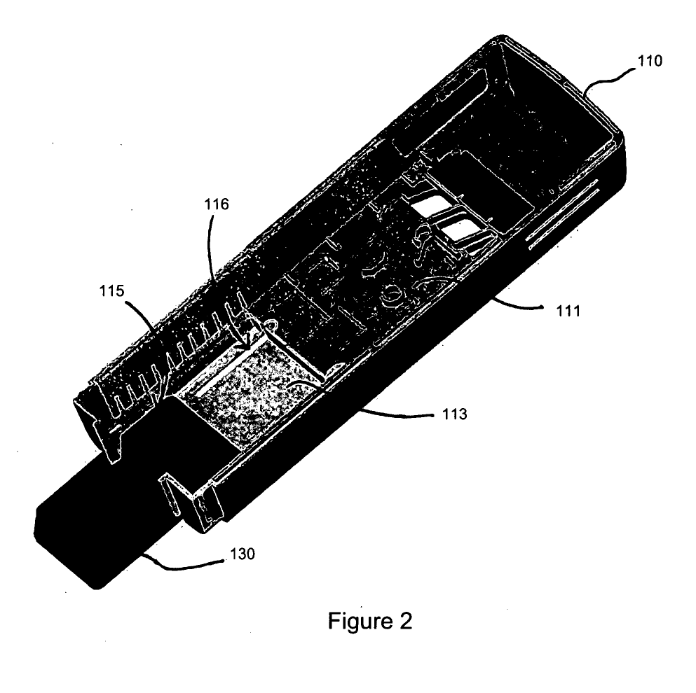

Referring now to FIG. 2, the inside of the upper housing 110 of the electronic device 110 is illustrated with the electronic card 130 partially inserted. In the illustrated embodiment, the upper housing 110 is provided with an electronic card receiving portion 113. The electronic card receiving portion 113 may be formed integrally with the upper housing 113 or, as illustrated in FIG. 2, may be formed as an insert which is secured to the inner surface 111 of the upper housing 113. In this regard, the electronic card receiving portion 113 may be an insert made of any material. In one embodiment, the insert is formed of a metal. In order to reduce costs associated with machining of metal, the insert may be formed of an amorphous alloy, such as Liquidmetal®, through the use of a mold.

In order to facilitate insertion and ejection of the electronic card 130 into or out of the electronic card receiving portion 113, the electronic card receiving portion 113 may be provided with tracks 115 formed on the outer edges. In this regard, the edges of the electronic card 130 may slide on the tracks 115 for proper insertion and ejection.

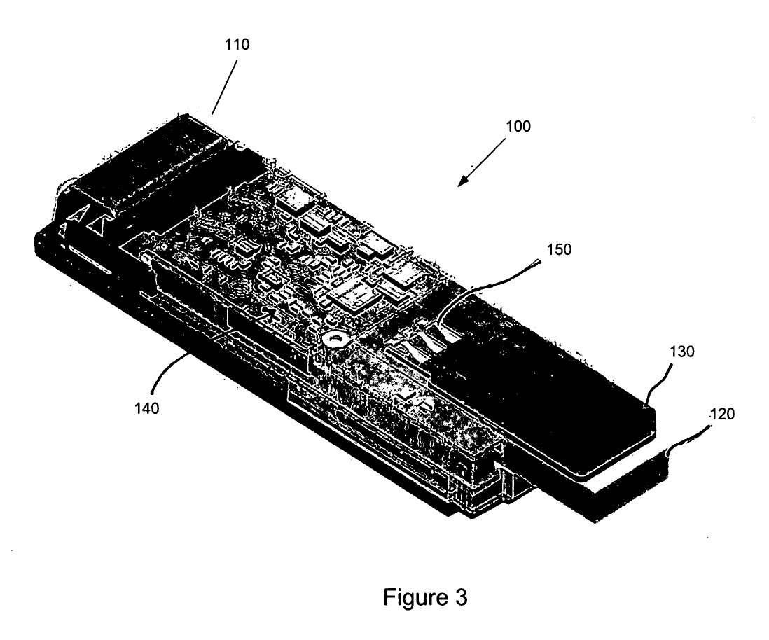

Referring now to FIG. 3, a perspective view of the electronic device 100 is illustrated with the upper housing shown as a wireframe. Again, the electronic card 130 is shown as partially inserted. As illustrated in FIG. 3, the electronic device 100 may include numerous electronic components 140 for proper operation of the electronic device 100. Further, the electronic device 110 includes conductive contacts 150 adapted to engage corresponding contacts (not shown) on the electronic card 130 when the electronic card 130 is completely inserted into the electronic card receiving portion 113. Thus, when the electronic card 130 is completely inserted, information stored on the electronic card 130 may be accessed by the electronic device 100 through the conductive contacts 150.

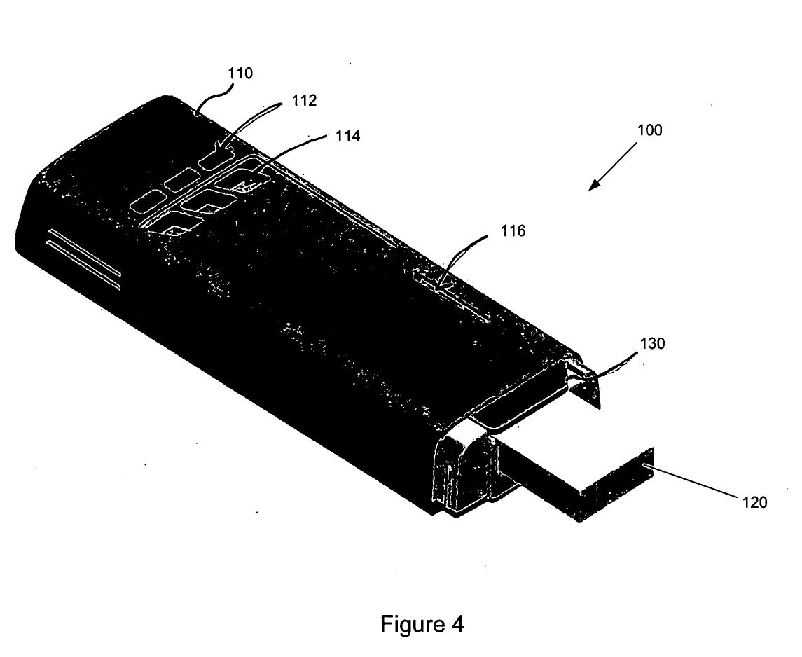

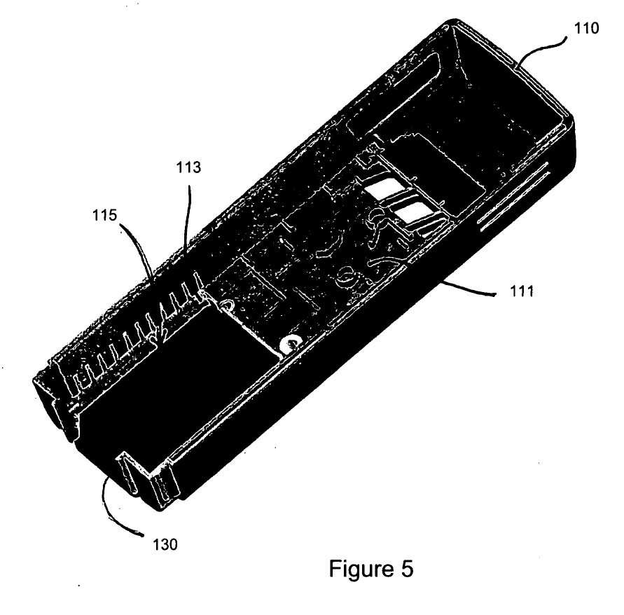

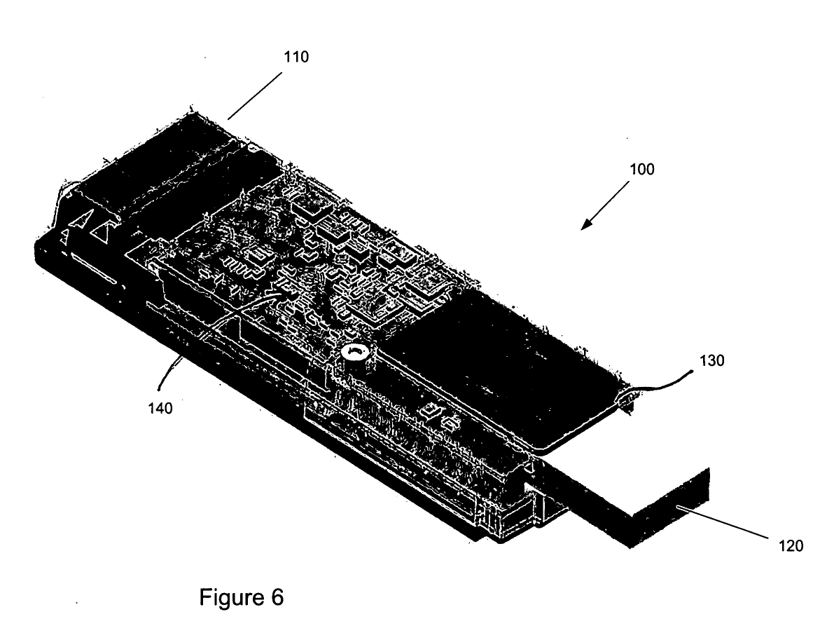

FIGS. 4-6 illustrate the views of FIGS. 1-3, respectively, of the electronic device 100 with the electronic card 130 completely inserted into the electronic card receiving portion 113. In the illustrated configuration, the electronic card receiving portion 113 is positioned such that the electronic card 130 inserted therein is positioned above the USB connector. In other embodiments, the electronic card receiving portion 113 may be positioned such that the electronic card 130 inserted therein is positioned below the USB connector. Further embodiments may position the electronic card receiving portion 113 such that the electronic card 130 is in another configuration in proximity of the USB connector.

When the electronic device 100 is to be connected to a host device (not shown), the connector 120 is interfaced with the host device by insertion of the connector 120 into a corresponding port of the host device. Thus, when the connector 120 is interfaced with the host device, physical removal of the electronic card in the electronic card receiving portion is inhibited. In this regard, when the connector 120, such as a USB connector, is inserted into a corresponding port, such as a USB port, movement of the electronic card 130 is restricted by the physical structure of the host device.

When removal of the electronic card 130 is desired, the user must first disengage the electronic device 100 from the host device. The user may then eject the electronic card 130 from the electronic card receiving portion 113 by inserting an object into the card ejection slot 116 and urging the electronic card 130 outward.

Thus, by requiring disengagement of the electronic device 100 from the host device, accidental or inadvertent removal of the electronic card 130 is avoided.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

1. An electronic device, comprising:
a connector for interfacing with a host device; and
an electronic card receiving portion,
wherein the electronic card receiving portion is part of a housing, and
wherein the electronic card receiving portion is configured to inhibit physical removal of an electronic card therein when the connector is interfaced with the host device.

2. (canceled)

3. The electronic device of claim 1, wherein the housing is formed of molded plastic or plastic extruded on or attached to a metal.

4. The electronic device of claim 1, wherein the electronic card receiving portion is an insert secured within the housing.

5. The electronic device of claim 4, wherein the insert is formed of an amorphous alloy.

6. The electronic device of claim 1, wherein the card receiving portion is formed of an amorphous alloy.

7. The electronic device of claim 1, wherein the electronic card receiving portion includes tracks along which the electronic card can be inserted or removed.

8. The electronic device of claim 1, wherein electronic card receiving portion includes a card ejection slot adapted to facilitate removal of the electronic card.

9. The electronic device of claim 1, wherein the connector is a universal serial bus (USB) connector.

10. The electronic device of claim 9, wherein the electronic card receiving portion is positioned such that an electronic card inserted therein is positioned above or below the USB connector.

11. The electronic device of claim 9, wherein the electronic card receiving portion is positioned such that an electronic card inserted therein is positioned in proximity of the USB connector.

12. The electronic device of claim 1, wherein the electronic card receiving portion is adapted to receive a subscriber identity module (SIM) card.

13. A modem device, comprising:
a universal serial bus (USB) connector for interfacing with a host device; and
an electronic card receiving portion,
wherein the electronic card receiving portion is part of a housing, and
wherein the electronic card receiving portion is configured to inhibit physical removal of an electronic card therein when the USB connector is interfaced with the host device.

14. The modem device of claim 13, wherein the electronic card receiving portion includes tracks along which the electronic card can be inserted or removed.

15. The modem device of claim 13, wherein electronic card receiving portion includes a card ejection slot adapted to facilitate removal of the electronic card.

16. The modem device of claim 13, wherein the electronic card receiving portion is positioned such that an electronic card inserted therein is positioned above or below the USB connector.

17. The modem device of claim 13, wherein the electronic card receiving portion is positioned such that an electronic card inserted therein is positioned in proximity of the USB connector.

18. The modem device of claim 13, wherein the electronic card receiving portion is adapted to receive a subscriber identity module (SIM) card.

19. A modem system, comprising:
a universal serial bus (USB) connector for interfacing with a host device;
an electronic card receiving portion; and
an electronic card removably positioned within the electronic card receiving portion,
wherein the electronic card receiving portion is part of a housing, and
wherein the electronic card receiving portion is configured to inhibit physical removal of the electronic card therein when the USB connector is interfaced with the host device.

20. The modem system of claim 19, wherein the electronic card is a subscriber identity module (SIM) card.
